(19) United States
(12) Patent Application Publication
(10) Pub. No.: US 2021/0301469 A1
(43) Pub. Date: Sep. 30, 2021

(54) FIBER-FORMED BODY PRODUCING RAW MATERIAL AND FIBER-FORMED BODY PRODUCING METHOD

(71) Applicant: SEIKO EPSON CORPORATION, Tokyo (JP)

(72) Inventors: Shigemi WAKABAYASHI, Azumino (JP); Masahiko NAKAZAWA, Matsumoto (JP); Hiroki KURATA, Matsumoto (JP); Naotaka HIGUCHI, Suwa-gun (JP); Yoshihiro UENO, Shiojiri (JP); Shunichi SEKI, Suwa (JP); Nobutaka URANO, Matsumoto (JP); Takehiko UEHARA, Chikuma (JP)

(21) Appl. No.: 17/215,161

(22) Filed: Mar. 29, 2021

(30) Foreign Application Priority Data
Mar. 31, 2020 (JP) 2020-064810

(51) Int. Cl. D21H 11/14; D21B 1/06; D21H 17/53

(52) U.S. Cl. CPC D21H 11/14; D21H 17/53; D21B 1/06

(57) ABSTRACT

A fiber-formed body producing raw material contains fibers and a binder for binding the fibers, wherein the fiber-formed body producing raw material is nongranular, and 1.0≤A/B≤9.0, wherein A is a weight of the fibers in the fiber-formed body producing raw material and B is a weight of the binder in the fiber-formed body producing raw material.

The present application is based on, and claims priority from JP Application Serial Number 2020-064810, filed Mar. 31, 2020, the disclosure of which is hereby incorporated by reference herein in its entirety.

### BACKGROUND

### 1. Technical Field

The present disclosure relates to a fiber-formed body producing raw material and a fiber-formed body producing method.

### 2. Related Art

In recent years, a sheet producing apparatus based on a dry system in which water is not used as much as possible has been proposed as described in, for example, JP-A-2015-92032. The sheet producing apparatus according to JP-A-2015-92032 includes a raw material supplying portion for supplying a raw material, a defibrating portion for defibrating the supplied raw material, a mixing portion for mixing a defibrated material produced in the defibrating portion with a complex containing a resin serving as a binder, an accumulating portion for accumulating a mixture produced in the mixing portion, and a forming portion for pressurizing and forming an accumulated material produced in the accumulating portion.

In addition, the mixing portion includes a supplying portion for supplying the complex containing the resin, a tube and the like for supplying the defibrated material and the complex. Fibers and the complex are mixed in such a mixing portion and, thereafter, are formed into a sheet-like shape in the forming portion.

In this regard, in a sheet producing apparatus according to JP-A-2015-92032, a sheet is produced from the raw material, the resulting sheet is used and, thereafter, is reused as a raw material. That is, the raw material is repetitively recycled. However, regarding repeat recycle, the number average fiber length of fibers is decreased in each time of recycling, and there is a concern that the strength of the sheet may become insufficient.

### SUMMARY

The present disclosure was made to address the above-described problems and can be realized as described below.

A fiber-formed body producing raw material according to an aspect of the present disclosure contains fibers and a binder for binding the fibers, wherein the fiber-formed body producing raw material is nongranular, and 1.0≤A/B≤9.0, wherein A is a weight of the fibers in the fiber-formed body producing raw material and B is a weight of the binder in the fiber-formed body producing raw material.

A fiber-formed body producing method according to another aspect of the present disclosure includes a supplying step of supplying a main raw material containing fibers and the fiber-formed body producing raw material according to the above aspect of the present disclosure, a defibrating step of defibrating the supplied main raw material and fiber-formed body producing raw material, an accumulating step of accumulating a defibrated material of the main raw material and the fiber-formed body producing raw material, the defibrated material being produced in the defibrating step, and a forming step of forming an accumulated material by heating and pressurizing, the accumulated material being produced in the accumulating step.

A fiber-formed body producing method according to another aspect of the present disclosure includes a supplying step of supplying a main raw material containing first fibers and supplying an auxiliary raw material containing second fibers and a binder for binding the first fibers to the second fibers, a defibrating step of defibrating and mixing the main raw material and the auxiliary raw material, that are supplied in the supplying step, so as to produce a mixture, and a forming step of forming the mixture into a fiber-formed body by heating and pressurizing, wherein a weight ratio of the binder is higher in the auxiliary raw material than in the main raw material and a number average fiber length of the second fibers is greater than a number average fiber length of the first fibers.

### BRIEF DESCRIPTION OF THE DRAWINGS

FIG. 1 is a schematic configuration diagram illustrating a fiber-formed body producing apparatus for performing a fiber-formed body producing method according to an embodiment of the present disclosure.

FIG. 2 is a perspective view illustrating an example of a main raw material supplied together with a fiber-formed body producing raw material according to the embodiment of the present disclosure.

FIG. 3 is a perspective view illustrating an example of the fiber-formed body producing raw material according to the embodiment of the present disclosure.

### DESCRIPTION OF EXEMPLARY EMBODIMENTS

A fiber-formed body producing raw material and a fiber-formed body producing method according to embodiments of the present disclosure will be described below in detail with reference to the attached drawings.

### First Embodiment

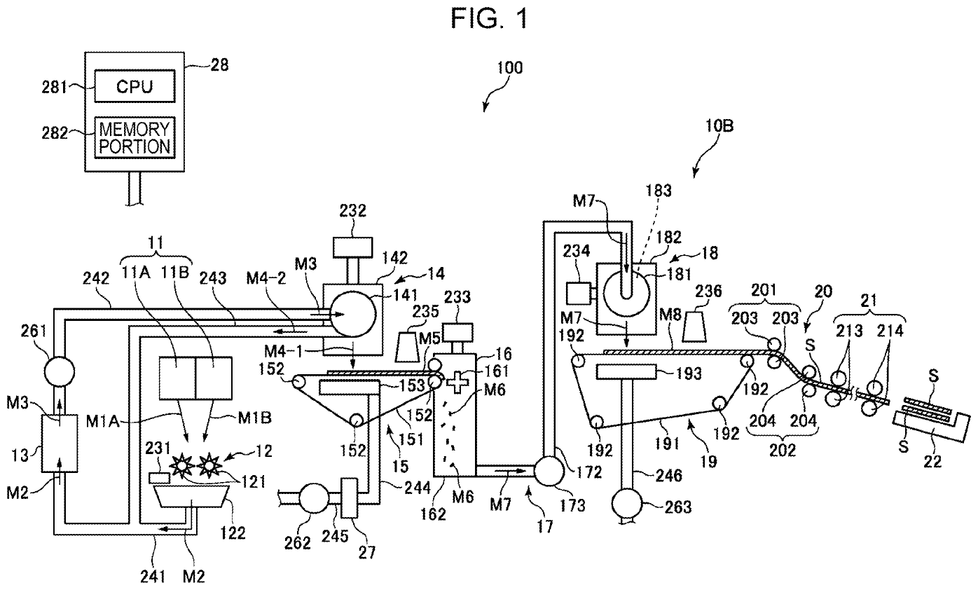

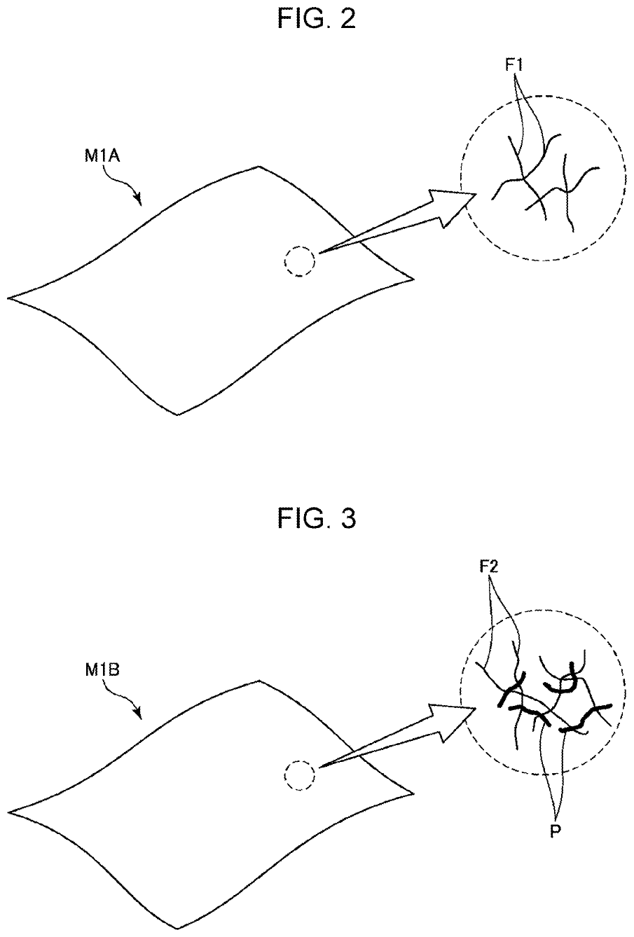

FIG. 1 is a schematic configuration diagram illustrating a fiber-formed body producing apparatus for performing a fiber-formed body producing method according to an embodiment of the present disclosure. FIG. 2 is a perspective view illustrating an example of a main raw material supplied together with a fiber-formed body producing raw material according to the present embodiment. FIG. 3 is a perspective view illustrating an example of the fiber-formed body producing raw material according to the present embodiment.

In this regard, FIG. 1 is a schematic configuration diagram, and the positional relationship between the portions of a fiber-formed body producing apparatus 100 is different from the positional relationship illustrated in the drawing. In the drawing, the direction in which a raw material M1A, coarsely crushed pieces M2, a defibrated material M3, a first sorted material M4-1, a second sorted material M4-2, a first web M5, a shredded material M6, a mixture M7, a second web M8, or a sheet S is transported, that is, the direction indicated by the arrow, is also referred to as “transportation direction”. In this regard, the leading-end-side direction of the arrow is also referred to as “downstream in the transportation direction” and the base-end-side direction is also referred to as “upstream in the transportation direction”.

The fiber-formed body producing apparatus 100 illustrated in FIG. 1 is an apparatus for obtaining a formed body by coarsely crushing, defibrating, mixing, and accumulating the raw material M1A and the raw material M1B and forming the resulting accumulated material in a forming portion 20.

In this regard, the formed body produced by the fiber-formed body producing apparatus 100 may be, for example, sheet-like such as recycled paper or block-like. Meanwhile, there is no particular limitation regarding the density of the formed body. The formed body may be a sheet having a relatively high fiber density or may be a sponge body having a relatively low fiber density. The formed body may have these characteristics in a mixed manner.

Hereafter the resulting formed body is explained as a sheet S that is recycled paper.

The fiber-formed body producing apparatus 100 illustrated in FIG. 1 includes a raw material supplying portion 11, a coarsely crushing portion 12, a defibrating portion 13, a sorting portion 14, a first web producing portion 15, a shredding portion 16, a mixing portion 17, a dispersing portion 18, a second web producing portion 19, a forming portion 20, a cutting portion 21, a stocking portion 22, a recovering portion 27, and a controlling portion 28 for controlling operations of these.

Further, the fiber-formed body producing apparatus 100 includes a humidifying portion 231, a humidifying portion 232, a humidifying portion 233, a humidifying portion 234, a humidifying portion 235, and a humidifying portion 236. In addition, the fiber-formed body producing apparatus 100 includes a blower 261, a blower 262, and a blower 263.

The controlling portion 28 controls the operation of each portion of the fiber-formed body producing apparatus 100 so as to perform the fiber-formed body producing method according to the present embodiment. The controlling portion 28 has a central processing unit (CPU) 281 and a memory portion 282. The CPU 281 can perform various types of programs stored in the memory portion 282 and can perform, for example, various types of decisions and various types of instructions.

The controlling portion 28 may be incorporated in the fiber-formed body producing apparatus 100 or may be disposed in external equipment such as an external computer. For example, the external equipment may communicate with the fiber-formed body producing apparatus 100 through a cable or the like, may communicate by radio, or may be coupled to the fiber-formed body producing apparatus 100 through a network such as the Internet. For example, the CPU 281 and the memory portion 282 may be integrated so as to constitute a single unit, the CPU 281 may be incorporated in the fiber-formed body producing apparatus 100 and the memory portion 282 may be disposed in external equipment such as an external computer, or the memory portion 282 may be incorporated in the fiber-formed body producing apparatus 100 and the CPU 281 may be disposed in external equipment such as an external computer.

In the fiber-formed body producing apparatus 100, a raw material supplying step, a coarsely crushing step, a defibrating step, a sorting step, a first web producing step, a fragmenting step, a mixing step, a releasing step, an accumulating step, a forming step, and a cutting step are performed in this order.

The configuration of each portion will be described below.

The raw material supplying portion 11 is a portion for performing the raw material supplying step of supplying the raw material M1A serving as the main raw material and the raw material M1B serving as the auxiliary raw material to the coarsely crushing portion 12. The raw material M1A illustrated in FIG. 2 may be a fibrous material, that is, a fiber-containing material containing fiber F1. The raw material M1A may be used or unnecessary waste paper. Meanwhile, the raw material M1B illustrated in FIG. 3 may be a material containing fiber F2 and a binder P. In this regard, the raw material M1B is the fiber-formed body producing raw material according to the present embodiment.

As illustrated in FIG. 2 and FIG. 3, the raw material M1A is sheet-like. However, the raw material M1A is not limited to this and may be block-like, pellet-like, cotton-like, or fragment-like. In addition, the raw material M1B is sheet-like. However, the raw material M1B is not limited to this and may be block-like, pellet-like, cotton-like, or fragment-like. The raw material M1A and the raw material M1B may take on a state of being stacked and bonded so as to constitute a multilayer body and may be supplied in the raw material supplying step.

Materials constituting the raw material M1A and the raw material M1B will be described later in detail.

The raw material supplying portion 11 may be configured to reserve the raw material M1A and the raw material M1B in different two reserving portions or may be configured to reserve them in a single reserving portion. That is, as illustrated in the drawing, the raw material supplying portion 11 may have a first reserving portion 11A for reserving the raw material M1A and a second reserving portion 11B for reserving the raw material M1B or may have a reserving portion for reserving the raw material M1A and the raw material M1B together.

The coarsely crushing portion 12 is a portion for performing the coarsely crushing step of coarsely crushing, in gas such as in the air, the raw material M1A and the raw material M1B supplied from the raw material supplying portion 11. The coarsely crushing portion 12 has a pair of coarsely crushing blades 121 and a chute 122.

The pair of coarsely crushing blades 121 rotate in the directions opposite to each other, and thereby the raw material M1A and the raw material M1B can be coarsely crushed, that is, cut, between the blades so as to be made into coarsely crushed pieces M2. The shape and the size of the coarsely crushed pieces M2 may be suitable for defibration treatment in the defibrating portion 13, and they may be fragments having a length per side of 100 mm or less and, in particular, may be fragments having a length per side of 10 mm or more and 70 mm or less.

The chute 122 is arranged below the pair of coarsely crushing blades 121 and is in the shape of, for example, a funnel. Consequently, the chute 122 can receive the coarsely crushed pieces M2 that drop after being coarsely crushed by the coarsely crushing blades 121.

Above the chute 122, the humidifying portion 231 is arranged adjoining the pair of coarsely crushing blades 121. The humidifying portion 231 humidifies the coarsely crushed pieces M2 in the chute 122. The humidifying portion 231 is composed of a vaporizing type humidifier that has a filter containing water and that supplies, to the coarsely crushed pieces M2, humidified air having humidity increased by the air being passed through the filter. The humidified air being supplied to the coarsely crushed pieces M2 enables the coarsely crushed pieces M2 to be suppressed from attaching to the chute 122 and the like due to static electricity.

The chute 122 is coupled to the defibrating portion 13 through a tube 241. The coarsely crushed pieces M2 collected into the chute 122 pass through the tube 241 and are transported to the defibrating portion 13.

The defibrating portion 13 is a portion for performing the defibrating step of defibrating the coarsely crushed pieces M2 in gas, that is, in a dry system. The defibrated material M3 can be produced from the coarsely crushed pieces M2 by defibration treatment in the defibrating portion 13. Herein, “defibrate” denotes disentangling the coarsely crushed pieces M2, which are composed of a plurality of fibers bonded to each other, into individual fibers. The disentangled material constitutes the defibrated material M3. The shape of the defibrated material M3 is linear or belt-like. The defibrated material M3 may be present while being entangled into a block-like shape, that is, while constituting a so-called “lump”.

The defibrating portion 13 in, for example, the present embodiment is composed of an impeller mill having a rotary blade that rotates at a high speed and a liner located outside the circumference of the rotary blade. The coarsely crushed pieces M2 that flow into the defibrating portion 13 are pinched between the rotary blade and the liner so as to be defibrated.

In addition, the defibrating portion 13 can generate a stream of air, that is, air stream, from the coarsely crushing portion 12 toward the sorting portion 14 by the rotation of the rotary blade. Consequently, the coarsely crushed pieces M2 can be suctioned from the tube 241 to the defibrating portion 13. After the defibration treatment, the defibrated material M3 can be sent to the sorting portion 14 through the tube 242.

The blower 261 is disposed on the way of the tube 242. The blower 261 is an air stream generator for generating the air stream toward the sorting portion 14. Consequently, sending of the defibrated material M3 to the sorting portion 14 is facilitated.

The sorting portion 14 is a portion performing the sorting step of sorting the defibrated material M3 based on the dimension of the length of the fiber. In the sorting portion 14, the defibrated material M3 is sorted into a first sorted material M4-1 and a second sorted material M4-2 larger than the first sorted material M4-1. The first sorted material M4-1 has a size suitable for production of a sheet S thereafter and may have an average fiber length of 500 μm or more and 3,000 μm or less. Meanwhile, the second sorted material M4-2 includes, for example, insufficiently defibrated materials and materials in which defibrated fibers are excessively flocculated.

The sorting portion 14 has a drum portion 141 and a housing portion 142 for housing the drum portion 141.

The drum portion 141 is composed of a cylindrical net body and is a sieve that rotates about the center axis thereof. The defibrated material M3 flows into the drum portion 141. The defibrated material M3 smaller than the openings of the net is sorted as the first sorted material M4-1, and the defibrated material M3 having a size larger than or equal to that of the openings of the net is sorted as the second sorted material M4-2 based on the rotation of the drum portion 141.

The first sorted material M4-1 drops from the drum portion 141.

Meanwhile, the second sorted material M4-2 is sent to the tube 243 coupled to the drum portion 141. The tube 243 is coupled to the tube 241 on the opposite side from the drum portion 141, that is, downstream. The second sorted material M4-2 passing through the tube 243 merges with the coarsely crushed pieces M2 in the tube 241 and flows into the defibrating portion 13 together with the coarsely crushed pieces M2. Consequently, the second sorted material M4-2 is returned to the defibrating portion 13 so as to be subjected to defibration treatment with the coarsely crushed pieces M2.

The first sorted material M4-1 dropped from the drum portion 141 drops toward the first web producing portion 15 located below the drum portion 141 while dispersing into the air. The first web producing portion 15 is a portion for performing the first web producing step of producing a first web M5 from the first sorted material M4-1. The first web producing portion 15 has a mesh belt 151, three stretching rollers 152, and a suctioning portion 153.

The mesh belt 151 is an endless belt and accumulates the first sorted material M4-1. The mesh belt 151 is looped over three stretching rollers 152. The first sorted material M4-1 on the mesh belt 151 is transported downstream by rotationally driving the stretching rollers 152.

The size of the first sorted material M4-1 is larger than or equal to that of the openings of the mesh belt 151. Consequently, the first sorted material M4-1 is hindered from passing through the mesh belt 151 and, therefore, can be accumulated on the mesh belt 151. Since the first sorted material M4-1 is transported downstream together with the mesh belt 151 while accumulating on the mesh belt 151 and, therefore, is made into the layered first web M5.

In this regard, there is a concern that the first sorted material M4-1 may include, for example, dust and dirt. Dust and dirt may be generated due to coarse crushing or defibration. Such dust and dirt are recovered in the recovering portion 27 described later.

The suctioning portion 153 is a suction mechanism for suctioning the air from below the mesh belt 151. Consequently, dust and dirt passing through the mesh belt 151 can be suctioned together with the air.

The suctioning portion 153 is coupled to the recovering portion 27 through the tube 244. Dust and dirt suctioned in the suctioning portion 153 are recovered in the recovering portion 27.

The tube 245 is further coupled to the recovering portion 27. The blower 262 is disposed on the way of the tube 245. The suction force of the suctioning portion 153 can be generated by an operation of the blower 262. Consequently, production of the first web M5 on the mesh belt 151 is facilitated. Dust and dirt are removed from the first web M5. Dust and dirt reach the recovering portion 27 through the tube 244 by an operation of the blower 262.

The housing portion 142 is coupled to the humidifying portion 232. The humidifying portion 232 is composed of a vaporizing type humidifier. Consequently, humidified air is supplied into the housing portion 142. The first sorted material M4-1 can be humidified by the humidified air, and thereby the first sorted material M4-1 can be suppressed from attaching to the inner wall of the housing portion 142 due to electrostatic force.

The humidifying portion 235 is arranged downstream of the sorting portion 14. The humidifying portion 235 is composed of an ultrasonic humidifier that sprays water. Consequently, water can be supplied to the first web M5, and thereby the amount of water in the first web M5 is adjusted. This adjustment enables the first web M5 to be suppressed from adsorbing to the mesh belt 151 due to electrostatic force. Consequently, the first web M5 is readily peeled off the mesh belt 151 at the position at which the mesh belt 151 is turned by the stretching roller 152.

The shredding portion 16 is arranged downstream of the humidifying portion 235. The shredding portion 16 is a portion performing the fragmenting step of fragmenting the first web M5 peeled off the mesh belt 151. The shredding portion 16 has a rotatably supported propeller 161 and a housing portion 162 for housing the propeller 161. The first web M5 can be fragmented by the rotating propeller 161. The shredded first web M5 serves as a shredded material M6. The shredded material M6 drops in the housing portion 162.

The housing portion 162 is coupled to the humidifying portion 233. The humidifying portion 233 is composed of a vaporizing type humidifier. Consequently, humidified air is supplied into the housing portion 162. The humidified air can also suppress the shredded material M6 from attaching to the propeller 161 and the inner wall of the housing portion 162 due to electrostatic force.

The mixing portion 17 is arranged downstream of the shredding portion 16. The mixing portion 17 is a portion for performing the mixing step of agitating and mixing the shredded material M6. The mixing portion 17 has a tube 172 and a blower 173.

The tube 172 couples the housing portion 162 of the shredding portion 16 to a housing 182 of the dispersing portion 18 and is a flow passage through which a mixture M7 produced by agitating and mixing fiber F1, fiber F2, and a binder P in the shredded material M6 passes.

The blower 173 is disposed on the way of the tube 172. Mixing of the fiber F1, the fiber F2, and the binder P is facilitated by an operation of the rotating portion such as a blade included in the blower 173. The blower 173 can generate an air stream toward the dispersing portion 18. The fiber F1, the fiber F2, and the binder P can be agitated in the tube 172 by the resulting air stream. Consequently, the mixture M7 in the state in which the fiber F1, the fiber F2, and the binder P are uniformly dispersed is transported to the dispersing portion 18. The fiber F1, the fiber F2, and the binder P in the mixture M7 are disentangled during passing through the tube 172 so as to take on a finer fiber state.

As illustrated in FIG. 1, the blower 173 is electrically coupled to the controlling portion 28, and the operation is controlled. The amount of the air blown by the blower 173 being adjusted enables the amount of the air fed into a drum 181 to be adjusted.

Although not illustrated in the drawing, the drum-181-side end portion of the tube 172 is bifurcated, and the bifurcated end portions are coupled to the respective inlets, not illustrated, disposed in the end surface of the drum 181.

The dispersing portion 18 illustrated in FIG. 1 is a portion for performing the releasing step of disentangling and releasing fibers entangled with each other in the mixture M7. The dispersing portion 18 has the drum 181 for introducing and releasing the mixture M7 that is a defibrated material, the housing 182 for housing the drum 181, and a driving source 183 for rotationally driving the drum 181.

The drum 181 is composed of a cylindrical net body and is a sieve that rotates about the center axis thereof. Of the mixture M7, fibers and the like smaller than the openings of the net can pass through the drum 181 based on the rotation of the drum 181. At this time, the mixture M7 is disentangled and is released together with the air. That is, the drum 181 functions as the releasing portion for releasing a material containing fibers.

Although not illustrated in the drawing, the driving source 183 has a motor, a decelerator, and a belt. The motor is electrically coupled to the controlling portion 28 with a motor driver interposed therebetween. The torque output from the motor is decelerated by the decelerator. The belt is composed of, for example, an endless belt and is looped over an output shaft of the decelerator and the outer circumference of the drum. Consequently, the torque of the output shaft of the decelerator is transmitted to the drum 181 with the belt interposed therebetween.

The housing 182 is coupled to the humidifying portion 234. The humidifying portion 234 is composed of a vaporizing type humidifier. Consequently, humidified air is supplied into the housing 182. The humidified air can humidify inside the housing and thereby can also suppress the mixture M7 from attaching to the inner wall of the housing 182 due to electrostatic force.

The mixture M7 released from the drum 181 drops toward the second web producing portion 19 located below the drum 181 while dispersing into the air. The second web producing portion 19 is a portion for performing the accumulating step of producing a second web M8 that is an accumulated material by accumulating the mixture M7. The second web producing portion 19 has a mesh belt 191, stretching rollers 192, and a suctioning portion 193.

The mesh belt 191 is a mesh member and is composed of an endless belt in the configuration illustrated in the drawing. The mixture M7 dispersed and released by the dispersing portion 18 is accumulated on the mesh belt 191. The mesh belt 191 is looped over four stretching rollers 192. The mixture M7 on the mesh belt 191 is transported downstream by rotationally driving the stretching rollers 192.

The configuration illustrated in the drawing is a configuration in which the mesh belt 191 is used as an example of the mesh member. However, the present disclosure is not limited to this, and, for example, a planar material may be adopted.

The size of most of the mixture M7 on the mesh belt 191 is larger than or equal to that of the openings of the mesh belt 191. Consequently, the mixture M7 is hindered from passing through the mesh belt 191 and, therefore, can be accumulated on the mesh belt 191. The mixture M7 is transported downstream together with the mesh belt 191 while accumulating on the mesh belt 191 and, therefore, is made into the layered second web M8.

The suctioning portion 193 is a suction mechanism for suctioning the air from below the mesh belt 191. Consequently, the mixture M7 can be suctioned onto the mesh belt 191 and, therefore, accumulation of the mixture M7 on the mesh belt 191 can be facilitated.

The tube 246 is coupled to the suctioning portion 193. The blower 263 is disposed on the way of the tube 246. The suction force of the suctioning portion 193 can be generated by an operation of the blower 263.

The humidifying portion 236 is arranged downstream of the dispersing portion 18. The humidifying portion 236 is composed of an ultrasonic humidifier as in the humidifying portion 235. Consequently, water can be supplied to the second web M8, and thereby the amount of water in the second web M8 is adjusted. This adjustment enables the second web M8 to be suppressed from adsorbing to the mesh belt 191 due to electrostatic force. Consequently, the second web M8 is readily peeled off the mesh belt 191 at the position at which the mesh belt 191 is turned by the stretching roller 192.

In this regard, the total amount of water added in the humidifying portion 231 to the humidifying portion 236 may be, for example, 0.5 parts by mass or more and 20 parts by mass or less relative to 100 parts by mass of the material before humidification.

The forming portion 20 is arranged downstream of the second web producing portion 19. The forming portion 20 is a portion for performing the forming step of forming a sheet S from the second web M8. The forming portion 20 has a pressurizing portion 201 and a heating portion 202.

The pressurizing portion 201 has a pair of calender rollers 203, and the second web M8 can be pressurized between the calender rollers 203 without performing heating. Consequently, the density of the second web M8 can be increased. In this regard, if heating is performed, the extent of heating may be, for example, the extent that does not melt the binder P. The second web M8 is transported toward the heating portion 202. One of the pair of calender rollers 203 is a main driving roller driven by an operation of a motor, not illustrated in the drawing, and the other is a driven roller.

The heating portion 202 has a pair of heating rollers 204, and the second web M8 can be heated between the heating rollers 204 while being pressurized. By this heating and pressurizing, the binder P in the second web M8 is melted, and the fibers are bonded to each other with the binder P interposed therebetween. Consequently, the sheet S is produced. The resulting sheet S is transported toward the cutting portion 21. One of the pair of heating rollers 204 is a main driving roller driven by an operation of a motor, not illustrated in the drawing, and the other is a driven roller.

The cutting portion 21 is arranged downstream of the forming portion 20. The cutting portion 21 is a portion for performing the cutting step of cutting the sheet S. The cutting portion 21 has a first cutter 211 and a second cutter 212.

The first cutter 211 cuts the sheet S in the direction intersecting, in particular, the direction orthogonal to, the transportation direction of the sheet S.

The second cutter 212 cuts the sheet S in the direction parallel to the transportation direction of the sheet S downstream of the first cutter 211. The cutting is for removing unnecessary portions of both side end portions of the sheet S in the width direction so as to straighten the width of the sheet S, and the portions removed by cutting are so-called “deckle edges”.

The sheet S having the predetermined shape and size is obtained by cutting with such first cutter 211 and second cutter 212. The resulting sheet S is further transported downstream so as to be accumulated in the stocking portion 22.

The forming portion 20 is not limited to having the configuration in which the sheet S is formed as described above and may have a configuration in which, for example, a block-like formed body, a spherical formed body, or the like is formed.

As described above, the fiber-formed body producing method according to the present embodiment includes the supplying step of supplying the raw material M1A that is a main raw material containing fibers and the raw material M1B that is the fiber-formed body producing raw material according to the present embodiment, the defibrating step of defibrating the supplied raw material M1A and raw material M1B, the accumulating step of accumulating the defibrated material M3 of the raw material M1A and the raw material M1B, the defibrated material M3 being produced in the defibrating step, and the forming step of forming the second web M8 by pressurization, the accumulated material being produced in the accumulating step. Consequently, the sheet S can be produced by supplying, defibrating, and forming the raw material M1A and the raw material M1B. That is, the binder P being supplied together with the fiber F1 and the fiber F2 enables disposition of a binder supplying portion in the midstream of the apparatus to be omitted. Therefore, the apparatus can be reduced in size. Further, since the raw material M1B described later is used, when the sheet S is produced from the raw material M1A and the raw material M1B and the resulting sheet S is used and reused as the raw material, the sheet S having sufficient strength can be obtained. That is, excellent repeat recyclability is exhibited.

Meanwhile, a fiber-formed body producing method according to another embodiment of the present disclosure includes a supplying step of supplying the raw material M1A that is a main raw material containing the fiber F1 serving as first fibers and supplying the raw material M1B that is an auxiliary raw material containing the fiber F2 serving as second fibers and the binder P for binding the fiber F1 to the fiber F2, a defibrating step of defibrating and mixing the raw material M1A and the auxiliary raw material M1B, supplied in the supplying step, so as to produce the mixture M7, and a forming step of forming the mixture M7 into a fiber-formed body by heating and pressurizing. A weight ratio of the binder P is higher in the raw material M1B than in the raw material M1A, and a number average fiber length of the fiber F2 is greater than a number average fiber length of the fiber F1. Consequently, the raw material M1A and the raw material M1B can be supplied, defibrated, and formed so as to produce the sheet S. That is, the binder P being supplied together with the fiber F1 and the fiber F2 enables disposition of a binder supplying portion in the midstream of the apparatus to be omitted. Therefore, the apparatus can be reduced in size. Further, since the weight ratio of the binder P is higher in the raw material M1B than in the raw material M1A and the number average fiber length of the fiber F2 is greater than the number average fiber length of the fiber F1, when the sheet S is produced from the raw material M1A and the raw material M1B and the resulting sheet S is used and reused as the raw material, the number average fiber length of fibers included in the sheet S that is a fiber-formed body is not excessively decreased, and the sheet S having sufficient strength can be obtained. That is, repeat recyclability can be further enhanced.

Next, materials constituting the raw material M1A and the raw material M1B will be described in detail.

The raw material M1A contains the fiber F1 and is a main raw material composed of fiber. Examples of the fiber F1 include fiber derived from a plant, fiber derived from an animal, resin fiber, glass fiber, and carbon fiber and mixtures of these.

Examples of the fiber derived from a plant include cellulose fiber, cotton, linter, kapok, flax, hemp, ramie, and silk. These can be used alone or at least two types can be used in combination. Of these, fiber mainly containing cellulose fiber may be adopted. The cellulose fiber is readily available and has excellent formability into the sheet S, and sufficient strength is obtained.

Examples of the cellulose fiber may include fiber derived from wood pulp. Examples of the wood pulp include virgin pulp such as hardwood pulp, softwood pulp, and cotton linter, kraft pulp, bleached chemithermomechanical pulp, synthetic pulp, and pulp derived from waste paper or recycled paper. These can be used alone or at least two types can be used in combination.

Herein, the cellulose fiber may be any fibrous material containing cellulose as a compound, that is, cellulose in a narrow sense, as a primary component. Materials containing hemicellulose or lignin other than cellulose in a narrow sense are applicable.

Examples of the fiber derived from an animal include wool.

Examples of the resin fiber include polyamides, Tetron, rayon, cupra, acetate, vinylon, acryl, polyethylene terephthalate, and aramid.

There is no particular limitation regarding the number average fiber length of the fiber F1. The length may be 0.5 mm or more and 3.0 mm or less and, in particular, 0.7 mm or more and 2.5 mm or less. Consequently, binding by using the binder P is favorably performed, and excellent formability and sufficient strength are obtained.

In this regard, the number average fiber length L_{N} is represented by Formula (1) below.

$${L}_{N} = - \frac{\sum {n}_{i} \cdot {l}_{i}}{\sum {n}_{i}} \qquad ( 1 )$$

In Formula (1), nᵢ denotes the number of fibers of the fraction i, lᵢ denotes the length of fibers of the fraction i, and i denotes a natural number.

There is no particular limitation regarding the number average fiber diameter of the fiber F1. The diameter may be 0.1 μm or more and 50 μm or less and, in particular, 1 μm or more and 30 μm or less. Consequently, binding by using the binder P described later is favorably performed, and excellent formability and sufficient strength are obtained.

For the same reason, the average aspect ratio, that is, the ratio of the number average fiber length to the number average fiber diameter, of the fiber F1 may be 2 or more and 30,000 or less and, in particular, 10 or more and 300 or less.

The raw material M1A may contain other components, for example, the binder P described later, in addition to the fiber F1. In particular, when the raw material M1A is derived from the sheet S produced by the fiber-formed body producing apparatus 100, the binder P is included.

Next, the raw material M1B will be described.

The raw material M1B is a fiber-formed body producing raw material containing the fiber F2 and the binder P for binding fibers of the fiber F2 to each other. Meanwhile, in the present embodiment, the raw material M1B is used as the auxiliary raw material when the sheet S that is a fiber-formed body is produced by subjecting the raw material M1A that is a main raw material containing defibrated fibers to forming by heating and pressurizing. Consequently, when the raw material M1A is formed into the sheet S, fibers can be bound to each other so as to provide the sheet S with sufficient strength.

The raw material M1B takes on a nongranular form. Specifically, a form such as a sheet-like, pellet-like, spherical, rugby-ball-like, cylindrical, columnar, or dice-like form can be taken. Of these, a sheet-like form may be adopted from the viewpoint of handleability, apparatus size, and ease of working.

Examples of the fiber F2 include fiber derived from a plant, fiber derived from an animal, resin fiber, glass fiber, and carbon fiber and mixtures of these, which are described as examples of the fiber F1.

There is no particular limitation regarding the number average fiber length of the fiber F2. The length may be 0.7 mm or more and 3.0 mm or less and, in particular, 0.8 mm or more and 2.5 mm or less. When the raw material M1B is defibrated and formed so as to produce the sheet S, and the sheet S is used and thereafter used as the raw material M1A, that is, when repeat recycle is performed, the number average fiber length of fibers is decreased. However, even when repeat recycle is performed, sufficient strength is obtained by setting the number average fiber length to be relatively large as described above. That is, further excellent repeat recyclability is obtained.

If the number average fiber length of the fiber F2 is excessively small, when repeat recycle is performed, the strength of the sheet S tends to become insufficient. On the other hand, if the number average fiber length of the fiber F2 is excessively large, a load tends to be applied to the defibrating portion 13 during defibration, lumps may be readily generated after defibration, and there is a concern that the sheet quality may deteriorate.

There is no particular limitation regarding the number average fiber diameter of the fiber F2. The diameter may be 0.1 μm or more and 50 μm or less and, in particular, 1 μm or more and 30 μm or less. Consequently, binding by using the binder P described later is favorably performed, and excellent formability and sufficient strength are obtained.

For the same reason, the average aspect ratio, that is, the ratio of the number average fiber length to the number average fiber diameter, of the fiber F2 may be 2 or more and 30,000 or less and, in particular, 10 or more and 300 or less.

The binder P used can take on a granular or fibrous form or a combination of these. That is, the raw material M1B contains at least one of a granular binder P or a fibrous binder P. Consequently, the fiber F1 is readily efficiently bonded to the fiber F2 with the binder P interposed therebetween.

Regarding the binder P, for example, thermoplastic resins, curable resins, and the like can be used, and thermoplastic resins may be used. The binder P containing the thermoplastic resin suppresses the bondability from being realized until heating is performed in the forming portion 20 and enables lumps to be suppressed or prevented from being generated due to unwilling bonding until the fiber F1 and the fiber F2 are transported to the forming portion.

Examples of the thermoplastic resin include AS resins, ABS resins, polyolefins such as polyethylenes, polypropylenes, and ethylene-vinyl acetate copolymers (EVA), modified polyolefins, acrylic resins such as polymethyl methacrylates, polyvinyl chlorides, polystyrenes, polyesters such as polyethylene terephthalate and polybutylene terephthalate, polyamides such as Nylon 6, Nylon 46, Nylon 66, Nylon 610, Nylon 612, Nylon 11, Nylon 12, Nylon 6-12, and Nylon 6-66 (Nylon: registered trademark), polyamide-imides, polyphenylene ethers, polyacetals, polyethers, polyphenylene oxides, modified polyphenylene ethers, polyether ether ketones, polycarbonates, polyphenylene sulfides, thermoplastic polyimides, polyether imides, liquid crystal polymers such as aromatic polyesters, fluororesins such as polytetrafluoroethylenes, and various thermoplastic elastomers such as styrene-based, polyolefin-based, polyvinyl chloride-based, polyurethane-based, polyester-based, polyamide-based, polybutadiene-based, trans-polyisoprene-based, fluororubber-based, and chlorinated polyethylene-based thermoplastic elastomers. These can be used alone or at least two types can be used in combination. In particular, the thermoplastic resin may be a polyester or a resin containing a polyester. Meanwhile, biomass plastic and biodegradable plastic such as polylactic acid, polycaprolactam, various types of starch, polyhydroxybutyrate, polybutylene succinate, and polybutylene succinate adipate can be contained. Consequently, environmental suitability is improved.

In particular, the binder P may contain starch. Consequently, further excellent biodegradability is provided, and there are advantages in recycling the sheet S. Meanwhile, the starch may be a thermoplastic starch. Examples of the thermoplastic starch include internally plasticized starch and externally plasticized starch, and the thermoplastic starch may be externally plasticized starch, that is, may contain starch and an external plasticizer. Consequently, further excellent biodegradability is provided, and the sheet S can be more favorably recycled. Adjustment of the characteristics and the like of the starch can be further facilitated by adjusting, for example, the amount of the external plasticizer mixed.

In addition, curable resins such as thermosetting resins or photo-curable resins may be included. Examples of the thermosetting resins include epoxy resins and phenol resins. At least one of these can be included.

The raw material M1B can contain, in addition to the binder P, a coloring agent for coloring the fiber, a flocculation inhibitor for suppressing fibers from flocculating, a flame retarder for making fibers and the like flame-retardant, and a paper strength additive for enhancing the paper strength of the sheet S. These can be used alone or at least two types can be used in combination.

Herein, in the present embodiment, 1.0≤A/B≤9.0 is satisfied, wherein A is a weight of the fiber F2 in the raw material M1B and B is a weight of the binder P in the raw material M1B. Consequently, the amount of the fibers in the raw material M1B can be sufficiently ensured, and an appropriate amount of the binder P can be supplied. Therefore, the strength of the sheet S can be sufficiently ensured. If A/B is less than 1.0, since the amount of the fiber F2 is excessively small, the strength of repeat-recycled sheet S becomes insufficient. On the other hand, if A/B is more than 9.0, since the amount of the binder P is excessively small, binding between fibers of the fiber F2 becomes insufficient, and the strength of the sheet S becomes insufficient.

When 1.0≤A/B≤9.0 is satisfied, wherein A is a weight of the fiber F2 in the raw material M1B and B is a weight of the binder P in the raw material M1B, the effect of the present embodiment can be obtained. However, 1.2≤A/B≤8.5 may be satisfied and, in particular, 1.8≤A/B≤8.0 may be satisfied. Consequently, the effect of the present embodiment can be more obviously obtained.

In this regard, A may be 50% by weight or more and 90% by weight or less and, in particular, may be 55% by weight or more and 85% by weight or less. Consequently, the strength of the resulting sheet S can be further reliably enhanced.

In this regard, B may be 5% by weight or more and 50% by weight or less and, in particular, may be 10% by weight or more and 40% by weight or less. Consequently, the strength of the resulting sheet S can be further reliably enhanced.

The weight ratio of the binder P is higher in the raw material M1B than in the raw material M1A and the number average fiber length of the fiber F2, that is, the second fibers, contained in the raw material M1B is greater than the number average fiber length of the fiber F1, that is, the first fibers, contained in the raw material M1A. Consequently, the number average fiber length of the fibers is not readily reduced due to repeat recycle, and the repeat recyclability can be improved.

As described above, the raw material M1B that is an example of the fiber-formed body producing raw material according to the present embodiment is a fiber-formed body producing raw material containing the fiber F2 and the binder P for binding the fibers of the fiber F2 to each other, wherein the fiber-formed body producing raw material is nongranular, and 1.0≤A/B≤9.0 is satisfied, wherein A is the weight of the fiber F2 in the raw material M1B and B is the weight of the binder P in the raw material M1B.

The above-described raw material M1B can be supplied from the raw material supplying portion 11 and can be defibrated and formed so as to produce the sheet S. That is, the binder P being supplied together with the fiber F2 enables disposition of a binder supplying portion in the midstream of the apparatus to be omitted. Therefore, the apparatus can be reduced in size. Further, A/B satisfying 1.0≤A/B≤9.0 enables the amount of the fibers in the raw material M1B to be sufficiently ensured and an appropriate amount of the binder P to be supplied. When the sheet S is produced from the raw material M1A and the raw material M1B and the resulting sheet S is used and reused as the raw material, the sheet S having sufficient strength can be obtained. That is, excellent repeat recyclability is exhibited.

The raw material M1B serving as the fiber-formed body producing raw material may be sheet-like. Consequently, coarse crushing in the coarsely crushing portion 12 can be facilitated, the raw material M1B can be smoothly supplied to the defibrating portion 13 and can be favorably defibrated. In addition, when the raw material M1B is transported or when the raw material M1B is stored, the raw material M1B can be stacked, and these operations can be simply performed.

In the configuration of the present embodiment, the raw material M1A and the raw material M1B are supplied. However, the present disclosure is not limited to this, and the raw material M1B can be used as the main raw material. That is, in the configuration, the raw material M1B may be supplied alone to the fiber-formed body producing apparatus 100 without supplying the raw material M1A.

The embodiments of the present disclosure have been described above. However, the present disclosure is not limited to them.

For example, each portion constituting the fiber-formed body producing apparatus used for the fiber-formed body producing method can be replaced with any configuration capable of performing the same function. Meanwhile, any component may be added.

### EXAMPLES

Next, specific examples of the present disclosure will be described.

### 1. Production of Fiber-Formed Body Producing Raw Material

### Example 1

Initially, 7 kg of softwood pulp (number average fiber length: 2,300 μm or less) serving as the fiber and 3 kg of polylactic acid (“TERRAMAC” produced by UNITIKA LTD.) serving as the binder were prepared.

A heater mixer (trade name: Henschel Mixer FM20C/I produced by Mitsui Mining Co., Ltd.; upper blade: kneading type, lower blade: for high circulation-high load; provided with a heater and a thermometer; volume of 20 L) was heated to 140° C., 7 kg of softwood pulp was charged, and kneading was performed at an average peripheral speed of 50 m/sec. After a lapse of substantially 2 minutes, the softwood pulp became cotton-like.

Subsequently, 3 kg of polylactic acid was charged into the heater mixer, and kneading was continued at an average peripheral speed of 50 m/sec. When the temperature of the mixer reached 120° C., maleic-modified polypropylene (MPP: “MG-670P” produced by RIKEN VITAMIN CO., LTD.) was charged, and kneading was continued for 15 minutes.

Thereafter, the kneaded material was transferred to a cooling mixer (“Cooler Mixer FD20C/K” produced by Mitsui Mining Co., Ltd.; rotary blade: standard blade for cooling; provided with a cooling unit (20° C.) and a thermometer; volume of 45 L), kneading was started at an average peripheral speed of 10 m/sec, and kneading was stopped when the temperature in the mixer reached 80° C. The mixture of the cellulose fiber and the resin was solidified so as to obtain a fiber-formed body producing raw material of Example 1 that was a pellet-like raw material (auxiliary raw material) having a diameter of about 2 mm to 2 cm. Regarding the resulting raw material, A:B was 70:30, wherein A is the weight of the fiber and B is the weight of the binder.

When evaluation described later was performed, a waste paper recycling machine “PaperLab A-8000” produced by Seiko Epson Corporation was modified so that a container for storing the pellet-like raw material (auxiliary raw material), a pellet transporting portion, and a pellet crushing portion were coupled and mounted on a defibrating portion, and a waste-paper-recycled sheet was produced by charging used waste paper serving as the raw material M1A into a raw material supplying portion and supplying the pellet-like raw material (auxiliary raw material) serving as the raw material M1B to the defibrating portion through the pellet crushing portion. In the resulting waste-paper-recycled sheet, the polylactic acid content was 10% by weight. The evaluation of the waste-paper-recycled sheet will be described later.

### Example 2

After polylactic acid (“TERRAMAC” produced by UNITIKA LTD.) was coarsely crushed by using a hammer mill, pulverization was performed by using a jet mill, and granular polylactic acid having a volume average particle diameter of 10.6 μm was produced by using a forced vortex type centrifugal precision air classifier. A binder resin powder was produced by subjecting 1 kg of the resulting polylactic acid powder and 20 g of silicon dioxide fine particles to mixing treatment with a high-speed mixer. The binder resin powder was charged as the raw material M1B into a raw material supplying portion of the waste paper recycling machine “PaperLab A-8000” produced by Seiko Epson Corporation, and softwood pulp (sheet produced by papermaking so as to have a basis weight of 80 g/m²) was charged as the raw material M1A so as to produce a paperboard sheet having a weight ratio of softwood pulp:binder=70:30 and a basis weight of 120 g/m². The paperboard sheet was cut with a shredder so as to obtain a fiber-formed body producing raw material of Example 2 that was a shredded-piece-like raw material (auxiliary raw material).

When evaluation described later was performed, a waste paper recycling machine “PaperLab A-8000” produced by Seiko Epson Corporation was modified so that a container for storing the shredded-piece-like raw material (auxiliary raw material) and a shredded-piece transporting portion were coupled and mounted on a defibrating portion, and a waste-paper-recycled sheet was produced by charging used waste paper serving as the raw material M1A into a raw material supplying portion and charging the shredded-piece-like raw material (auxiliary raw material) serving as the raw material M1B into the shredded-piece transporting portion so as to supply to the defibrating portion. In the resulting waste-paper-recycled sheet, the polylactic acid content was 10% by weight. The evaluation of the waste-paper-recycled sheet was performed in the same manner as in Example 1.

### Example 3

A pulp slurry was produced by putting 9 g of softwood pulp and 21 g of polylactic acid powder produced in Example 2 into 1 liter of water and performing agitation by using a blender (“High Speed Blender” produced by Oster) at a peripheral speed of 50 m/sec for 30 seconds. After agitation, the pulp concentration was diluted to 0.8% by mass with water having a pH of 7.0, 30 g of retention aid (Polytension 1200 produced by ARAKAWA CHEMICAL INDUSTRIES LTD.) was added, and agitation was further performed for 5 minutes. After agitation, the resulting slurry was left to stand for 3 hours, and papermaking was performed by using a sheet machine produced by Noble and Wood. After pressing, drying was performed at 100° C. for 100 seconds by using a drum dryer so as to obtain a fiber-formed body producing raw material of Example 3 that was a sheet-like raw material (auxiliary raw material) having a basis weight of 80 g/m².

When evaluation described later was performed, a waste-paper-recycled sheet was produced by charging used waste paper serving as the raw material MIA into a main paper-supplying unit of a waste paper recycling machine “PaperLab A-8000” produced by Seiko Epson Corporation and charging the sheet-like raw material (auxiliary raw material) produced as described above into a sub-paper-supplying unit. In the resulting waste-paper-recycled sheet, the polylactic acid content was 10% by weight. The evaluation of the waste-paper-recycled sheet was performed in the same manner as in Example 1.

### Example 4

A polyester powder (volume average particle diameter of 11.2 μm) was produced by changing the polylactic acid in Example 2 to a polyester (“VYLON 220” produced by Toyobo Co., Ltd.) and a fiber-formed body producing raw material of Example 4 that was a sheet-like raw material (auxiliary raw material) was produced by changing the polylactic acid powder in Example 3 to the polyester powder. The sheet-like fiber-formed body producing raw material was used, a waste-paper-recycled sheet was produced in the same manner as in Example 3, and evaluation was performed in the same manner as in Example 1.

### Example 5

A fiber-formed body producing raw material of Example 5 was obtained in the same manner as in Example 4 except that the polyester in Example 4 was changed to polyurethane (“SUPERFLEX 130” produced by Dai-ichi Kogyo Seiyaku Co., Ltd.). Evaluation was performed in the same manner as in Example 4.

### Example 6

A fiber-formed body producing raw material of Example 6 was obtained in the same manner as in Example 4 except that the polyester in Example 4 was changed to polycarbonate (“DURABIO” produced by Mitsubishi Chemical Corporation). Evaluation was performed in the same manner as in Example 4.

### Example 7

A fiber-formed body producing raw material of Example 7 was obtained in the same manner as in Example 3 except that the softwood pulp in Example 3 was changed to cotton linter (number average fiber length: 1,500 μm or less). Evaluation was performed in the same manner as in Example 3.

### Example 8

A fiber-formed body producing raw material of Example 8 was obtained in the same manner as in Example 3 except that the softwood pulp in Example 3 was changed to hardwood pulp (number average fiber length: 800 μm or less). Evaluation was performed in the same manner as in Example 3.

### Example 9

A fiber-formed body producing raw material of Example 9 was obtained in the same manner as in Example 2 except that the polylactic acid in Example 2 was changed to a polyester (“VYLON 220” produced by Toyobo Co., Ltd.) and that the basis weight of the fiber-formed body producing raw material was changed to 80 g/m². Evaluation was performed in the same manner as in Example 3.

### Example 10

A fiber-formed body producing raw material of Example 10 was obtained in the same manner as in Example 9 except that the softwood pulp in Example 9 was changed to a polyester fiber (“TT04N” produced by Teijin Limited, number average fiber length: 5.0 mm). Evaluation was performed in the same manner as in Example 9.

### Example 11

A fiber-formed body producing raw material of Example 11 was obtained in the same manner as in Example 9 except that the softwood pulp in Example 9 was changed to a rayon resin (“CORONA” produced by Daiwabo Rayon Co., Ltd., number average fiber length: 8.0 mm). Evaluation was performed in the same manner as in Example 9.

### Comparative Example 1

The pellet-like fiber-formed body producing raw material produced in Example 1 was crushed by using a hammer mill and was further pulverized by using a jet mill. Subsequently, the resulting pulverized material was classified by using a forced vortex type centrifugal classifier so as to produce a powder-like complex binder. A fiber-formed body producing raw material of Comparative example 1 was produced by subjecting 1 kg of the resulting powder-like complex binder and 20 g of silicon dioxide fine particles to mixing treatment by using a high-speed mixer.

When evaluation described later was performed, a waste-paper-recycled sheet was produced by charging the fiber-formed body producing raw material of Comparative example 1 into a binder-supplying portion of a waste paper recycling machine “PaperLab A-8000” produced by Seiko Epson Corporation and charging used waste paper into a paper-supplying portion. In the resulting waste-paper-recycled sheet, the polylactic acid content was 10% by weight.

### Comparative Example 2

A fiber-formed body producing raw material of Comparative example 2 was obtained in the same manner as in Example 3 except that the amount of the softwood pulp mixed in Example 3 was changed to 18 g, and that the amount of polylactic acid mixed was changed to 12 g. Evaluation was performed in the same manner as in Example 3.

### Comparative Example 3

A fiber-formed body producing raw material of Comparative example 3 was obtained in the same manner as in Example 3 except that the amount of the softwood pulp mixed in Example 3 was changed to 1.5 g, and that the amount of polylactic acid mixed was changed to 28.5 g. Evaluation was performed in the same manner as in Example 3.

### Comparative Example 4

A fiber-formed body producing raw material of Comparative example 4 was obtained in the same manner as in Comparative example 2 except that the polylactic acid in Comparative example 2 was changed to a polyester. Evaluation was performed in the same manner as in Comparative example 2.

### Comparative Example 5

A fiber-formed body producing raw material of Comparative example 5 was obtained in the same manner as in Comparative example 2 except that the polylactic acid in Comparative example 2 was changed to a polyurethane. Evaluation was performed in the same manner as in Comparative example 2.

### Comparative Example 6

A fiber-formed body producing raw material of Comparative example 6 was obtained in the same manner as in Comparative example 2 except that the polylactic acid in Comparative example 2 was changed to a polycarbonate. Evaluation was performed in the same manner as in Comparative example 2.

### Comparative Example 7

A fiber-formed body producing raw material of Comparative example 7 was obtained in the same manner as in Comparative example 3 except that the polylactic acid in Comparative example 3 was changed to a polyester. Evaluation was performed in the same manner as in Comparative example 3.

### Comparative Example 8

A fiber-formed body producing raw material of Comparative example 8 was obtained in the same manner as in Comparative example 3 except that the polylactic acid in Comparative example 3 was changed to a polyurethane. Evaluation was performed in the same manner as in Comparative example 3.

### Comparative Example 9

A fiber-formed body producing raw material of Comparative example 9 was obtained in the same manner as in Comparative example 3 except that the polylactic acid in Comparative example 3 was changed to a polycarbonate. Evaluation was performed in the same manner as in Comparative example 3.

### 2. Evaluation

The fiber-formed body producing raw material of each of the above-described examples and each of the above-described comparative examples was evaluated as described below.

### 2-1. Handleability of Binder

A: Regarding handling of the fiber-formed body producing apparatus during use, nothing has to be prepared, and transportation and storage are readily performed.

B: Regarding handling of the fiber-formed body producing apparatus during use, nothing has to be prepared.

C: Regarding handling of the fiber-formed body producing apparatus during use, some equipment such as a wiping cloth, gloves, or a protective mask has to be prepared.

### 2-2. Apparatus Size

A: The apparatus size required for obtaining a fiber-formed body having sufficient strength is 2 m or less in height, 2 m or less in frontage, and 1.5 m or less in depth.

B: Any two of 2 m or less in height, 2 m or less in frontage, and 1.5 m or less in depth are satisfied and the other is not satisfied.

C: Any one of 2 m or less in height, 2 m or less in frontage, and 1.5 m or less in depth is satisfied and the others are not satisfied.

### 2-3. Repeat Recyclability

A: Repeat recycle can be performed 5 times or more.

B: Repeat recycle can be performed 2 times or more and less than 5 times.

C: Repeat recycle cannot be performed.

These results are collectively described in Table 1 and Table 2.

TABLE 1

| | Example 1 | Example 2 | Example 3 | Example 4 | Example 5 | Example 6 | Example 7 | Example 8 | Example 9 | Example 10 | Example 11 |
|---|---|---|---|---|---|---|---|---|---|---|---|
| Form | pellet | shredded | sheet | sheet | sheet | sheet | sheet | sheet | sheet | sheet | sheet |
| | | piece | | | | | | | | | |
| Type of | softwood | softwood | softwood | softwood | softwood | softwood | cotton | hardwood | softwood | polyester | rayon |
| fiber | pulp | pulp | pulp | pulp | pulp | pulp | linter | pulp | pulp | fiber | |
| Type of | polylactic | polylactic | polylactic | polyester | poly- | poly- | polylactic | polylactic | polyester | polyester | polyester |
| binder | acid | acid | acid | | urethane | carbonate | acid | acid | | | |
| Production | heater | dry | wet | wet | wet | wet | wet | wet | wet | dry | dry |
| method | mixer | paper- | paper- | paper- | paper- | paper- | paper- | paper- | paper- | paper- | paper- |
| | | making | making | making | making | making | making | making | making | making | making |
| | | shredder | | | | | | | | | |
| Weight ratio | 70:30 | 70:30 | 70:30 | 70:30 | 70:30 | 70:30 | 70:30 | 70:30 | 70:30 | 70:30 | 70:30 |
| A:B | | | | | | | | | | | |
| Handle- | A | A | A | A | A | A | A | A | A | A | A |
| ability | | | | | | | | | | | |
| Apparatus | B | B | A | A | A | A | A | A | A | A | A |
| size | | | | | | | | | | | |
| Repeat | A | A | A | A | A | A | A | A | A | A | A |
| recyclability | | | | | | | | | | | |

TABLE 2

| | Comparative | Comparative | Comparative | Comparative | Comparative | Comparative | Comparative | Comparative | Comparative |
|---|---|---|---|---|---|---|---|---|---|
| | example 1 | example 2 | example 3 | example 4 | example 5 | example 6 | example 7 | example 8 | example 9 |
| Form | powder | sheet | sheet | sheet | sheet | sheet | sheet | sheet | sheet |
| Type of | softwood | softwood | softwood | softwood | softwood | softwood | softwood | hardwood | softwood |
| fiber | pulp | pulp | pulp | pulp | pulp | pulp | pulp | pulp | pulp |
| Type of | polylactic | polylactic | polylactic | polyester | polyurethane | polycarbonate | polyester | polyurethane | polycarbonate |
| binder | acid | acid | acid | | | | | | |
| Production | hammer mill | wet | wet | wet | wet | wet | wet | wet | wet |
| method | jet mill | papermaking | papermaking | papermaking | papermaking | papermaking | papermaking | papermaking | papermaking |
| Weight ratio | 70:30 | 40:60 | 95:5 | 40:60 | 40:60 | 40:60 | 95:5 | 95:5 | 95:5 |
| A:B | | | | | | | | | |
| Handleability | C | A | A | A | A | A | A | A | A |
| Apparatus | C | A | C | A | A | A | C | C | C |
| size | | | | | | | | | |
| Repeat | A | C | A | C | C | C | A | A | A |
| recyclability | | | | | | | | | |

The fiber-formed body producing raw materials of Comparative example 1 to Comparative example 9 were supplied to an apparatus which had “Apparatus size” rated as “A” so as to produce respective sheets. Regarding Comparative examples 1, 3, and 7 to 9, sufficient strength was not obtained, and a sheet producing apparatus including a resin supplying portion in the midstream, as described in JP-A-2015-92032, had to be used. In particular, in Comparative example 1, a sheet could not be produced since the powder raw material attached on the way to the coarsely crushing portion and the defibrating portion.

Regarding Comparative examples 2 and 4 to 6, a sheet could be produced by using the fiber-formed body producing apparatus not including the binder supplying portion in the midstream, as illustrated in FIG. 1. However, since A/B did not satisfy 1.0≤A/B≤9.0, the repeat recyclability was insufficient.

On the other hand, regarding Examples 1 to 11, a sheet could be produced by using the fiber-formed body producing apparatus not including the binder supplying portion in the midstream, as illustrated in FIG. 1, and excellent repeat recyclability was exhibited.

As described above, in Examples 1 to 11, excellent results were obtained, whereas in Comparative examples 1 to 9, satisfactory results were not obtained.

What is claimed is:

1. A fiber-formed body producing raw material comprising:
fibers; and
a binder for binding the fibers, wherein
the fiber-formed body producing raw material is nongranular, and
1.0≤A/B≤9.0, wherein
A is a weight of the fibers in the fiber-formed body producing raw material and
B is a weight of the binder in the fiber-formed body producing raw material.

2. The fiber-formed body producing raw material according to claim 1, wherein
the fiber-formed body producing raw material is sheet-like.

3. The fiber-formed body producing raw material according to claim 1, wherein
the binder includes at least one of a granular binder or a fibrous binder.

4. The fiber-formed body producing raw material according to claim 1, wherein
the binder contains a thermoplastic resin.

5. The fiber-formed body producing raw material according to claim 1, wherein
the binder contains starch.

6. The fiber-formed body producing raw material according to claim 1, wherein
a number average fiber length of the fibers is 0.7 mm or more and 3.0 mm or less.

7. The fiber-formed body producing raw material according to claim 1, wherein
the fiber-formed body producing raw material is used as an auxiliary raw material when a fiber-formed body is produced by subjecting a main raw material containing defibrated fibers to forming by heating and pressurizing.

8. A fiber-formed body producing method comprising:
a supplying step of supplying a main raw material containing fibers and the fiber-formed body producing raw material according to claim 1;
a defibrating step of defibrating the supplied main raw material and fiber-formed body producing raw material;
an accumulating step of accumulating a defibrated material of the main raw material and the fiber-formed body producing raw material, the defibrated material being produced in the defibrating step; and
a forming step of forming an accumulated material by heating and pressurizing, the accumulated material being produced in the accumulating step.

9. A fiber-formed body producing method comprising:
a supplying step of supplying a main raw material containing first fibers and supplying an auxiliary raw material containing second fibers and a binder for binding the first fibers to the second fibers;
a defibrating step of defibrating and mixing the main raw material and the auxiliary raw material, supplied in the supplying step, so as to produce a mixture; and
a forming step of forming the mixture into a fiber-formed body by heating and pressurizing, wherein
a weight ratio of the binder is higher in the auxiliary raw material than in the main raw material and
a number average fiber length of the second fibers is greater than a number average fiber length of the first fibers.
